(19) United States
(12) Patent Application Publication
(10) Pub. No.: US 2014/0063820 A1
(43) Pub. Date: Mar. 6, 2014

(54) LAMP TUBE

(71) Applicant: LEXTAR ELECTRONICS CORPORATION, Hsinchu (TW)

(72) Inventors: Chun-Kuang Chen, Taipei City (TW); Fu-Tse Tang, New Taipei City (TW); Chia-Lun Tsai, Dacheng Township (TW)

(73) Assignee: LEXTAR ELECTRONICS CORPORATION, Hsinchu (TW)

(21) Appl. No.: 13/721,850

(22) Filed: Dec. 20, 2012

(30) Foreign Application Priority Data
Aug. 29, 2012 (TW) 101131361

(51) Int. Cl. F21V 29/00

(52) U.S. Cl. CPC F21V 29/20
USPC 362/373

(57) ABSTRACT

A lamp tube includes a light transmission tube, a heat dissipation structure, a die bonding substrate and at least one light source. The light transmission tube includes first guiding rails disposed on opposite positions of the inner wall thereof. The first guising rails and the inner wall of the light transmission tube form first grooves. The heat dissipation structure inserts into the light transmission tube, and includes a die bonding area, extending arms downwardly extended from opposite sides of the heat dissipation structure, and connecting arms connected to the extending arms. Each of the extending arms includes second guiding rails and second grooves. The second guiding rail is engaged with the first groove, and the first guiding rail is engaged with the second groove. The die bonding substrate is placed on the die bonding area. The light source is placed on the die bonding substrate.

### RELATED APPLICATIONS

This application claims priority to Taiwan Application Serial Number 101131361, filed Aug. 29, 2012, which is herein incorporated by reference.

### BACKGROUND

1. Technical Field

Embodiments of the present invention relate to an illumination device. More particularly, embodiments of the present invention relate to a lamp tube.

2. Description of Related Art

Due to the incoming shortage of fossil fuel, energy issues have been the focus of the development of modern technology. Concerning the application of illumination, to meet eco-friendly demands, the light emitting diode (LED) with advantages such as low power consumption and high efficiency has been widely applied in the illumination device.

To save the power of the illumination device, an LED lamp tube can be used to replace the fluorescent lamp. The LED lamp tube generally includes a transparent tube, a light bar and an aluminum extrusion bar. The light bar is placed on the aluminum extrusion bar. The aluminum extrusion bar inserts into the space in the tube from the opening at the end of the transparent tube.

However, in that only opposite ends of the lamp tube is fixed on the lamp tube holder and the length of the lamp tube is considerably greater than the width thereof, the central area of the lamp tube that is far away from the fixed ends is subject to a bending stress and thereby deformation in the lamp tube.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with one embodiment of the present invention, a lamp tube includes a light transmission tube, a heat dissipation structure, a die bonding substrate and at least one light source. The light transmission tube includes a pair of first guiding rails respectively disposed on opposite positions of an inner wall in the light transmission tube. The first guiding rails and the inner wall of the light transmission tube form a pair of first guiding grooves. The heat dissipation structure inserts into the light transmission tube. The heat dissipation structure includes an upper surface having a die bonding area, a pair of extending arms respectively and downwardly extended from opposite sides of the heat dissipation structure, and a pair of connecting arms respectively connected to the extending arms. Each of the extending arms includes a pair of second guiding rails and a pair of second guiding grooves. The second guiding rails are respectively engaged with the first guiding grooves, and the first guiding rails are respectively engaged with the second guiding grooves. The die bonding substrate is placed on the die bonding area. The light source is mounted on the die bonding substrate.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a partially perspective view of a lamp tube in accordance with one embodiment of the present invention;

FIG. 2 and FIG. 3 are free-body diagrams of the light transmission tube 100 bearing forces along different directions;

FIG. 4 is a cross-sectional view of the lamp tube in FIG. 1;

FIG. 5 is a cross-sectional view of the lamp tube in FIG. 1 with fasteners;

FIG. 6 is an experimental data chart with respect to the lamp tube in FIG. 1 and other conventional lamp tubes;

FIG. 7 is a stress-strain diagram in accordance with the experimental data of FIG. 6.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

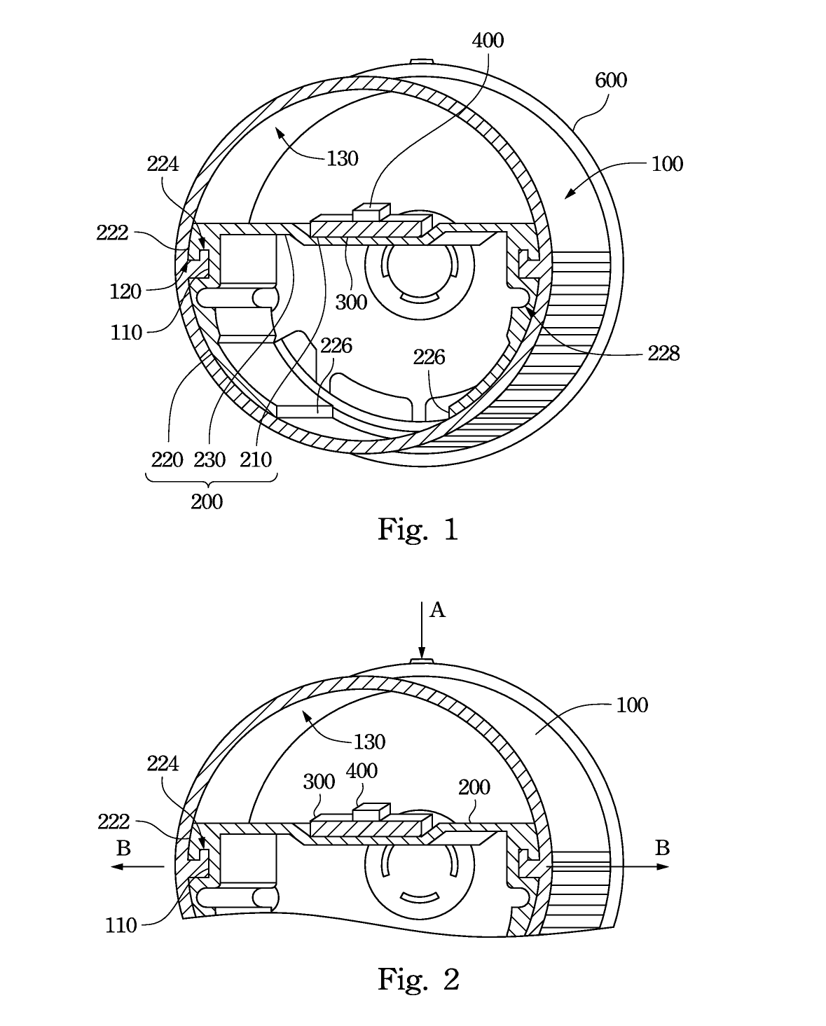

FIG. 1 is a partially perspective view of a lamp tube in accordance with one embodiment of the present invention. As shown in FIG. 1, the lamp tube includes a light transmission tube 100, a heat dissipation structure 200, a die bonding substrate 300 and at least one light source 400. The light transmission tube 100 includes a pair of first guiding rails 110 respectively disposed on opposite positions of an inner wall 130 in the light transmission tube 100. The first guiding rails 110 and the inner wall 130 of the light transmission tube 100 form a pair of first guiding grooves 120 therebetween. The heat dissipation structure 200 inserts into the light transmission tube 100. The heat dissipation structure 200 includes an upper surface having a die bonding area 210, a pair of extending arms 220 respectively and downwardly extended from opposite sides of the heat dissipation structure 200, and a pair of connecting arms 230 respectively connected to the extending arms 220. Each of the extending arms 220 includes a pair of second guiding rails 222 and a pair of second guiding grooves 224. The second guiding rails 222 are respectively engaged with the first guiding grooves 120, and the first guiding rails 110 are respectively engaged with the second guiding grooves 224. The die bonding substrate 300 is placed on the die bonding area 210. The light source 400 is mounted on the die bonding substrate 300.

In this embodiment, the light transmission tube 100 is hooked by the heat dissipation structure 200 due to the engagement between the first guiding rails 110 and the second guiding grooves 224 and the engagement between the second guiding rails 222 and the first guiding grooves 120. When the light transmission tube 100 bears external forces, the heat dissipation structure 200 applies forces to the inner wall 130 of the light transmission tube 100 to balance the external force, thereby preventing the light transmission tube 100 from bending or deforming.

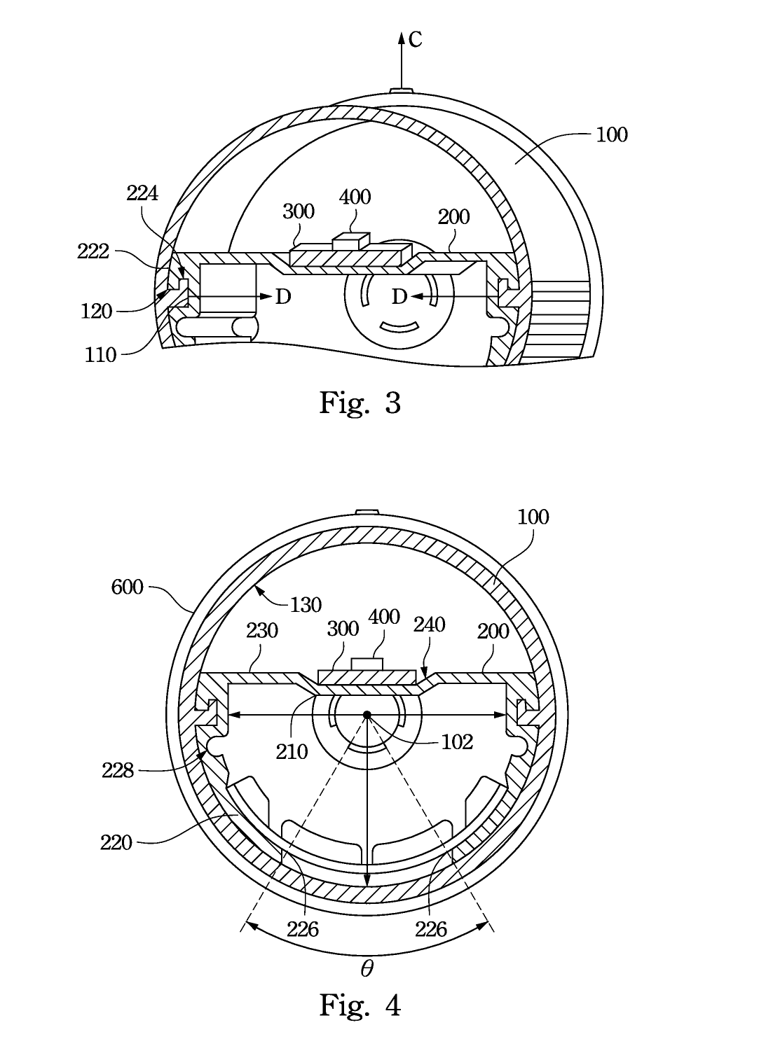

The forces relationship between the heat dissipation structure 200 and the light transmission tube 100 is shown in FIG. 2 and FIG. 3. FIG. 2 and FIG. 3 are free-body diagrams of the light transmission tube 100 bearing forces along different directions. In FIG. 2, the light transmission tube 100 bears an external force A pressing inwardly, two forces B dragging outwardly correspondingly occur, while the second guiding rails 222 of the heat dissipation structure 200 can prevent the first guiding rails 110 and the first guiding grooves 120 from moving outwardly because the second guiding rails 222 are engage with the first guiding grooves 120 of the light transmission tube 100 and press against the first guiding rails 110, thereby preventing the light transmission tube 100 from bending or deforming.

In FIG. 3, the light transmission tube 100 bears an external force C dragging outwardly, two forces D pressing inwardly correspondingly occur, while the second guiding grooves 224 of the heat dissipation structure 200 can tightly secure the first guiding rails 110 for preventing the first guiding rails 110 of the light transmission tube 100 from moving inwardly because the first guiding rails 110 are engage with the second guiding grooves 224, thereby preventing the light transmission tube 100 from bending or deforming.

Referring to FIG. 2 and FIG. 3, it is understood that whether the light transmission tube 100 bears the force A pressing inwardly or the force C dragging outwardly, the engagement between the second guiding rail 222 and the first guiding groove 120 and the engagement between the first guiding rail 110 and the second guiding groove 224 prevent the light transmission tube 100 from bending or deforming.

In some embodiments, the second guiding rail 222 and the first guiding groove 120 are complementary in shape. In other words, the size and shape of the second guiding rail 222 and which of the first guiding groove 120 match to each other, so that the second guiding rail 222 and the first guiding groove 120 can be engaged without gaps. For example, the second guiding rail 222 is a rectangular protrusion, and the first guiding groove 120 is a rectangular groove with the same shape and size.

In some embodiments, the first guiding rail 110 and the second guiding groove 224 are complementary in shape. In other words, the size and shape of the first guiding rail 110 and which of the second guiding groove 224 match to each other, so that the first guiding rail 110 and the second guiding groove 224 can be engaged without gaps. For example, the first guiding rail 110 is a rectangular protrusion, and the second guiding groove 224 is a rectangular groove with the same shape and size.

In some embodiments, the second guiding rail 222 and the first guiding groove 120 are complementary in shape, and the first guiding rail 110 and the second guiding groove 224 are complementary in shape. In other words, the size and shape of the first guiding rail 110 and which of the second guiding groove 224 match to each other, and the size and shape of the second guiding rail 222 and which of the first guiding groove 120 match to each other. For example, the first guiding rail 110 and the second guiding rail 222 is a rectangular protrusion, and the second guiding groove 224 and the first guiding groove 120 is a rectangular groove with shape and size the same as the rectangular protrusion.

FIG. 4 is a cross-sectional view of the lamp tube in FIG. 1. As shown in FIG. 4, the extending arms 220 are conformably attached to the inner wall 130 of the light transmission tube 100. In other words, the extending arms 220 immediately contact to the inner wall 130 of the light transmission tube 100 without gaps. Specifically, the curvature of each of the extending arms 200 is equal to the curvature of the inner wall 130 of the light transmission tube 100, so as to enable the extending arms 220 conformably attaching to the inner wall 130.

In this embodiment, each of the extending arms 220 includes a distal end 226, the distal ends 226 of the extending arms 220 are spatially separated. In other words, the distal ends 226 of the extending arms are separated without any contact. Specifically, the distal ends 226 of the extending arms 220 and the central axis 102 of the light transmission tube 100 respectively draw an imaginary line (See the dash line shown in FIG. 4), and an angle θ is included between the imaginary lines. If the angle θ is greater, the distance between the distal ends 226 of the extending arms 220 is longer, and the length of the extending arms is shorter, thereby reducing the weight of the heat dissipation structure 200. Preferably, the angle θ is less than or equal to 60 degrees.

In some embodiments, the die bonding substrate 300 and the light source 400 are positioned above the central axis 102 of the light transmission tube 100. The extending arms 220 are positioned at opposite sides of the die bonding substrate 300 and the opposite sides of the light source 400, and they extend along the direction away from the light source 400. In some embodiments, the extending arms 220 are symmetric with respect to the central axis 102.

In some embodiments, the die bonding area 210 is formed on a recess 240 on the top surface of the heat dissipation structure 200 for containing the die bonding substrate 300. In some embodiments, the die bonding area 210 is positioned above the central axis 102.

In some embodiments, the connecting arm 230 is connected between the die bonding area 210 and the extending arm 220. In other words, the connecting arm 230 extends from the opposite sides of the die bonding area 210 to the inner wall 130 of the light transmission tube 100. The extending arm 220 extends from the end of the connecting arm 230 distal from the die bonding area 210 downwardly along the inner wall 130. In some embodiments, the height of the connecting arm 230 is higher than the height of the die bonding area 210.

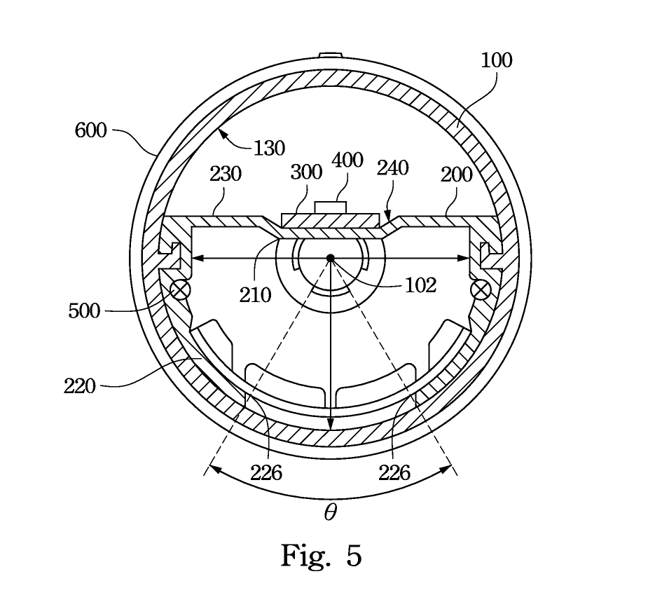

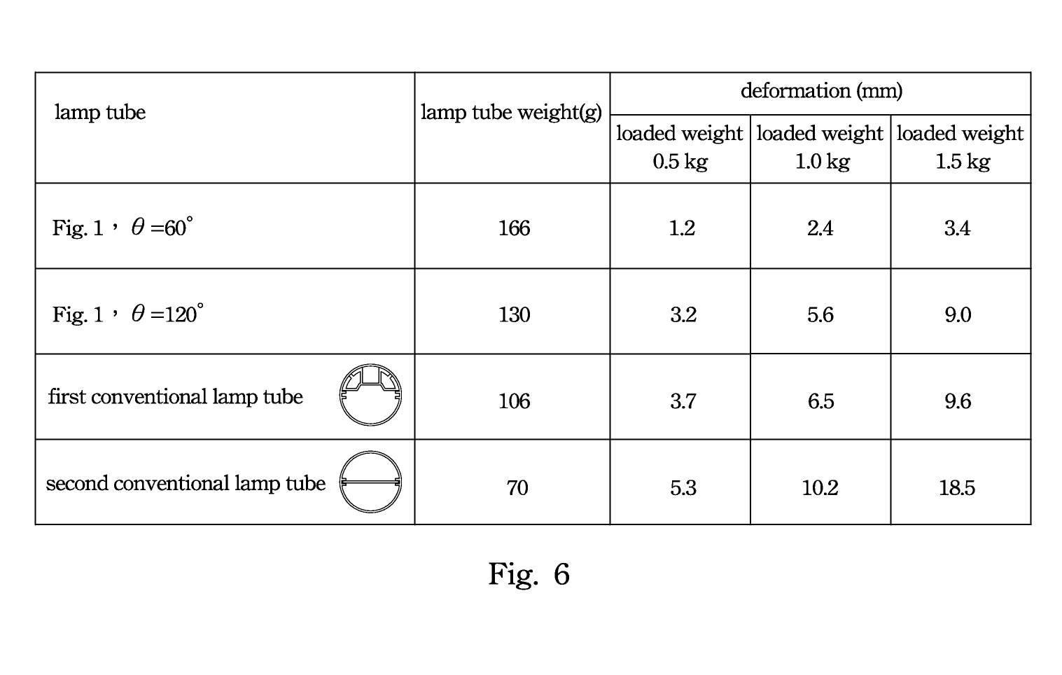

In some embodiments, each of the extending arms 220 includes a fastening groove 228, and the lamp tube includes a pair of fasteners 500 (See FIG. 5). The fasteners 500 are respectively fastened into the fastening grooves 228, so that the extending arms 220 can tightly press against the inner wall 130 of the light transmission tube 100.

In detail, the fastening groove 228 includes the male thread therein, and the outer surface of the fastener 500 includes the female thread thereon. The male thread is engaged with the female thread, so that the fastener 500 can be fastened into the fastening groove 228. In some embodiments, the fastening groove 228 is positioned on the extending arm 220 far away from the connecting arm 230, and the second guiding rail 222 and the second guiding groove 224 (See FIG. 3) are positioned on the extending arm 220 close to the connecting arm 230. In some embodiments, the fastening groove 228 is positioned beneath the central axis 102 of the light transmission tube 100, and the die bonding substrate 300 is positioned above the central axis 102.

In some embodiments, the lamp tube further includes end caps 600 covering the ends of the light transmission tube 100, so as to seal the light transmission tube 100, preventing dust or water from getting into the light transmission tube 100.

In some embodiments, the light source 400 is a LED. The LED may be, but is not limited to be, a LED package or a LED chip. The color of the light emitted by the LED may be, but is not limited to be, white, red, green or blue.

In some embodiments, the material of the heat dissipation structure 200 is metal. The metal may be, but is not limited to be, aluminum.

FIG. 6 is an experimental data chart with respect to the lamp tube in FIG. 1 and other conventional lamp tubes. The deformations corresponding to various loaded weight on the lamp tube are measured and recorded in this chart. In this experiment, opposite ends of the lamp tube are fixed, and objects with various weight are loaded at the center of the lamp tube, in which the loaded weight is 0.5, 1, or 1.5 kg. It is be noted that the first conventional lamp tube and the second conventional lamp tube do not include the first guiding rail 110, the second guiding groove 224, the second guiding rail 222 and the first guiding groove 120 disclosed in embodiments of the present invention.

It is clear that, when loading equal weight, the lamp tube in FIG. 1 deforms less than the first conventional lamp tube and the second conventional lamp tube. Therefore, the engagement between the first guiding rail 110 and the second guiding groove 224, and the engagement between the second guiding rail 222 and the first guiding groove 120 certainly prevent the lamp tube from bending and deforming. Further, if the angle θ of the lamp tube in FIG. 1 is 60 degrees, although this lamp tube is heavier than the lamp tube in FIG. 1 in which the angle θ is 120 degrees, the deformation is considerably reduced.

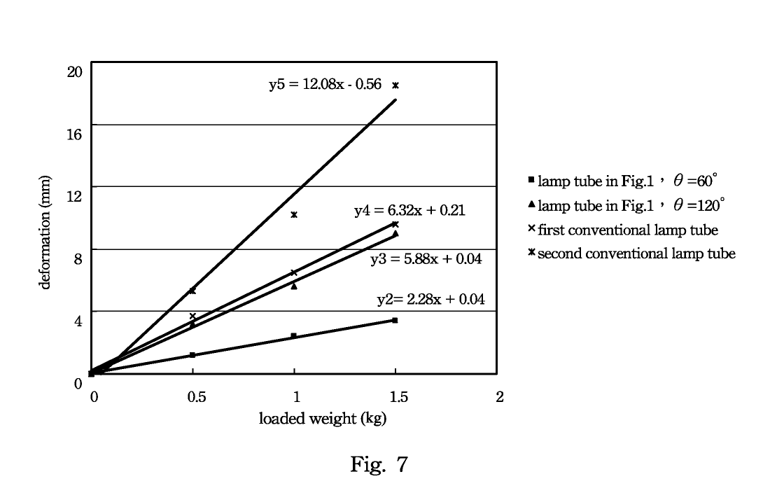

FIG. 7 is a stress-strain diagram in accordance with the experimental data in FIG. 6. When the weight loaded by the lamp tube is less than the yield strength, the loaded weight is linear to the deformation, and the bending modulus can be regarded as constant for facilitating to analyze the deformations corresponding to various loaded weight. As shown in FIG. 7, it is understood that, when loading equal weight, the second conventional lamp tube deforms more than the first conventional lamp tube, and the first conventional lamp tube deforms more than the lamp tube in FIG. 1 in which the angle θ is 120 degrees, and the lamp tube in FIG. 1 in which the angle θ is 120 degrees deforms more than the lamp tube in FIG. 1 in which the angle θ is 60 degrees. Therefore, the lamp tube in FIG. 1 in which the angle θ is 60 degrees is the preferred choice to prevent bend or deformation. It is noted that, the preferred choice mentioned above is made only based on the bending-resistant ability and the cost, and nevertheless, the manufacturer can modify the angle θ based on other demands.

It is noted that the description “the feature A is disposed on the feature B” in this specification not only refers to the embodiment that the feature A directly contacts the feature B, but also refers to the embodiment that an additional feature C is disposed between the feature A and the feature B.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A lamp tube, comprising:
a light transmission tube comprising a pair of first guiding rails respectively disposed on opposite positions of an inner wall in the light transmission tube, wherein the first guiding rails and the inner wall of the light transmission tube form a pair of first guiding grooves;
a heat dissipation structure inserting into the light transmission tube, wherein the heat dissipation structure comprising an upper surface having a die bonding area, a pair of extending arms respectively and downwardly extended from opposite sides of the heat dissipation structure, and a pair of connecting arms respectively connected to the extending arms, wherein each of the extending arms comprises a pair of second guiding rails and a pair of second guiding grooves, wherein the second guiding rails are respectively engaged with the first guiding grooves, and the first guiding rails are respectively engaged with the second guiding grooves;
a die bonding substrate placed on the die bonding area; and
at least one light source mounted on the die bonding substrate.

2. The lamp tube of claim 1, wherein the extending arms are conformably attached to the inner wall of the light transmission tube.

3. The lamp tube of claim 2, wherein each of the extending arms comprises a distal end, the distal ends of the extending arms are spatially separated.

4. The lamp tube of claim 3, wherein the distal ends of the extending arms and the central axis of the light transmission tube respectively draw an imaginary line, and an angle is included between the imaginary lines.

5. The lamp tube of claim 4, wherein the angle is less than or equal to 60 degrees.

6. The lamp tube of claim 5, wherein each of the extending arms comprises a fastening groove.

7. The lamp tube of claim 6, further comprising a pair of fasteners respectively fastened into the fastening grooves, so that each of the extending arms is immediately pressed against the inner wall of the light transmission tube.

8. The lamp tube of claim 1, wherein each of the extending arms comprises a fastening groove.

9. The lamp tube of claim 8, further comprising a pair of fasteners respectively fastened into the fastening grooves, so that each of the extending arms is immediately pressed against the inner wall of the light transmission tube.

10. The lamp tube of claim 1, wherein the second guiding rails and the first guiding grooves are complementary in shape.

11. The lamp tube of claim 1, wherein the first guiding rails and the second guiding grooves are complementary in shape.

12. The lamp tube of claim 1, wherein the second guiding rails and the first guiding grooves are complementary in shape, and the first guiding rails and the second guiding grooves are complementary in shape.

13. The lamp tube of claim 1, wherein the light source is a light emitting diode.

14. The lamp tube of claim 1, wherein the die bonding area is formed on a recess on the top surface of the heat dissipation structure.
